(19) United States
(12) Patent Application Publication
(10) Pub. No.: US 2017/0374229 A1
(43) Pub. Date: Dec. 28, 2017

(54) INFORMATION PROCESSING APPARATUS, IMAGE PROCESSING APPARATUS, AND NON-TRANSITORY COMPUTER READABLE MEDIUM

(71) Applicant: FUJI XEROX CO., LTD., Tokyo (JP)

(72) Inventor: Tetsuharu WATANABE, Kanagawa (JP)

(73) Assignee: FUJI XEROX CO., LTD., Tokyo (JP)

(21) Appl. No.: 15/295,145

(22) Filed: Oct. 17, 2016

(30) Foreign Application Priority Data
Jun. 24, 2016 (JP) 2016-125946

(51) Int. Cl. H04N 1/32; H04N 1/327; H04W 12/06; H04N 1/00

(52) U.S. Cl. CPC H04N 1/32106; H04N 1/00344; H04N 1/32518; H04N 1/32776; H04W 12/06; H04N 1/00307; H04N 2201/0039; H04N 2201/0055; H04N 2201/0094; H04N 2201/3205; H04N 2201/0041

(57) ABSTRACT

An information processing apparatus includes a registration unit and a processing unit. The registration unit registers multiple terminal devices with the information processing apparatus or a different apparatus in association with multiple operators who operate the multiple terminal devices. The processing unit executes a process by performing, in response to an instruction for the process given by a specific one of the operators, short-range communication with a specific one of the terminal devices that is registered in association with the specific one operator.

### CROSS-REFERENCE TO RELATED APPLICATIONS

This application is based on and claims priority under 35 USC 119 from Japanese Patent Application No. 2016-125946 filed Jun. 24, 2016.

### BACKGROUND

### Technical Field

The present invention relates to an information processing apparatus, an image processing apparatus, and a non-transitory computer readable medium.

### SUMMARY

According to an aspect of the invention, there is provided an information processing apparatus including a registration unit and a processing unit. The registration unit registers multiple terminal devices with the information processing apparatus or a different apparatus in association with multiple operators who operate the multiple terminal devices. The processing unit executes a process by performing, in response to an instruction for the process given by a specific one of the operators, short-range communication with a specific one of the terminal devices that is registered in association with the specific one operator.

### BRIEF DESCRIPTION OF THE DRAWINGS

An exemplary embodiment of the present invention will be described in detail based on the following figures, wherein:

FIG. 1 is a diagram illustrating an example overall configuration of an image reading system to which the exemplary embodiment is applied;

FIG. 2 is a diagram illustrating an example hardware configuration of an image reading apparatus in the exemplary embodiment;

FIG. 3 is a diagram illustrating an example hardware configuration of a mobile terminal in the exemplary embodiment;

FIG. 4 is a diagram illustrating an example hardware configuration of an authentication server in the exemplary embodiment;

FIG. 5 is a block diagram illustrating an example functional configuration of an information processing apparatus in the image reading apparatus in the exemplary embodiment;

FIG. 6 is a block diagram illustrating an example functional configuration of an image memory device in the mobile terminal in the exemplary embodiment;

FIG. 7 is a block diagram illustrating an example functional configuration of an information memory device in the authentication server in the exemplary embodiment;

FIG. 8A is a sequence diagram illustrating an example terminal registration operation performed in the image reading system to which the exemplary embodiment is applied;

FIG. 8B is a sequence diagram illustrating the example terminal registration operation performed in the image reading system to which the exemplary embodiment is applied; and

FIG. 9 is a sequence diagram illustrating an example scanning operation performed in the image reading system to which the exemplary embodiment is applied.

### DETAILED DESCRIPTION

Hereinafter, an exemplary embodiment of the invention will be described in detail with reference to the attached drawings.

### Overall Configuration of Image Reading System

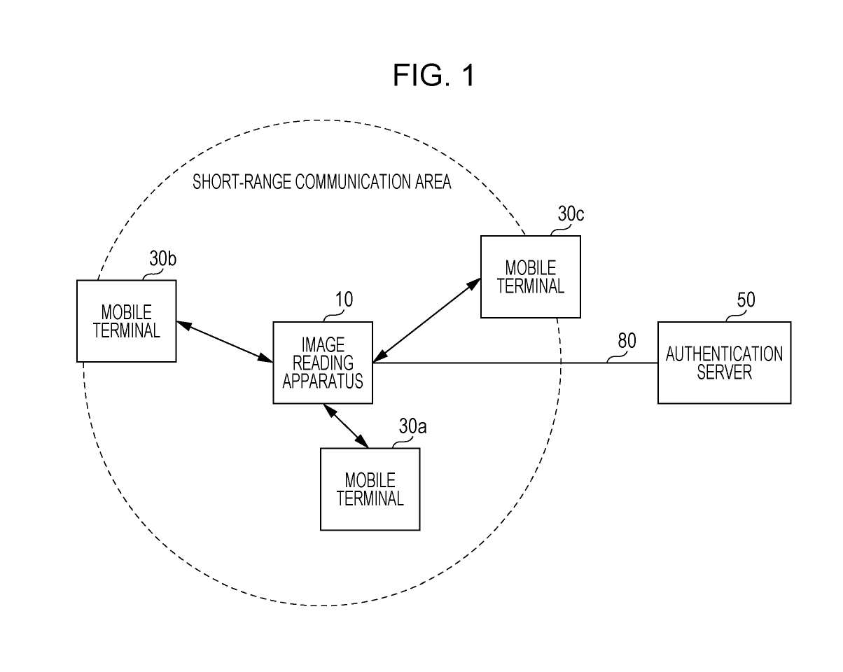

FIG. 1 is a diagram illustrating an example overall configuration of an image reading system to which the exemplary embodiment is applied. As illustrated in FIG. 1, the image reading system includes an image reading apparatus 10, mobile terminals 30a, 30b, and 30c, and an authentication server 50. Among these components, the image reading apparatus 10 is connectable to the mobile terminals 30a to 30c through short-range communication. For the short-range communication, for example, Bluetooth (registered trademark) low energy (hereinafter, referred to as BLE) may be used. When not being distinguished from each other, the mobile terminals 30a to 30c are referred to as mobile terminals 30. The number of the mobile terminals 30 is not limited to three. Although the mobile terminals 30a to 30c are arranged within the short-range communication area in the exemplary embodiment, for example, another mobile terminal 30 may be present outside the short-range communication area. The image reading apparatus 10 and the authentication server 50 are connected to each other through a communication network 80.

The image reading apparatus 10 reads (scans) an image from a recording medium having the image recorded thereon, such as paper. The image reading apparatus 10 is connectable to each mobile terminal 30 through short-range communication as described above and may transmit the scanned image as scan data to the mobile terminal 30. The image reading apparatus 10 may have only a scanner function of reading (scanning) an image from a recording medium but, in the following description, also has a printer function of forming an image on a recording medium and a fax machine function of transmitting and receiving image data.

The mobile terminal 30 is a computer that stores therein image data transmitted by the image reading apparatus 10. That is, as described above, the mobile terminal 30 is connectable to the image reading apparatus 10 through short-range communication and causes the image reading apparatus 10 to identify the mobile terminal 30 by using terminal identification information used for uniquely identifying the mobile terminal 30. When, for example, BLE is used for the short-range communication, for example, a Bluetooth (registered trademark) device (BD) address may be used as the terminal identification information. For example, a smartphone may be used as the mobile terminal 30.

The authentication server 50 is a server computer that authenticates a user when the user uses the image reading apparatus 10. For example, a personal computer (PC) may be used as the authentication server 50.

The communication network 80 is used for information communication between the image reading apparatus 10 and the authentication server 50 and is, for example, the Internet. Hardware Configuration of Image Reading Apparatus

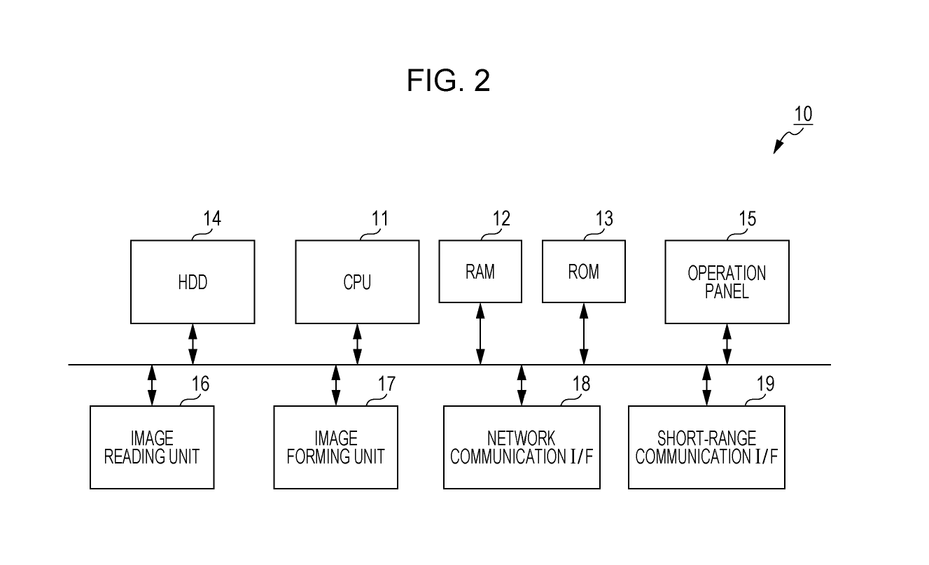

FIG. 2 is a diagram illustrating an example hardware configuration of the image reading apparatus 10 in the exemplary embodiment. As illustrated in FIG. 2, the image reading apparatus 10 includes a central processing unit (CPU) 11, a random access memory (RAM) 12, a read only memory (ROM) 13, a hard disk drive (HDD) 14, an operation panel 15, an image reading unit 16, an image forming unit 17, a network communication interface (hereinafter, referred to as a network communication I/F) 18, and a short-range communication interface (hereinafter, referred to as a short-range communication I/F) 19.

The CPU 11 implements various functions (described later) by loading various programs and the like stored in the ROM 13 into the RAM 12 and by running the programs.

The RAM 12 is used as a work memory or the like for the CPU 11.

The ROM 13 stores the various programs and the like run by the CPU 11.

The HDD 14 is, for example, a magnetic disk device used for storing image data read by the image reading unit 16, image data used by the image forming unit 17 for forming an image, and other data.

The operation panel 15 is, for example, a touch panel that displays various pieces of information and receives an input operation performed by the user. The operation panel 15 includes a display on which the various pieces of information are displayed and a location detection sheet on which a location designated using a finger, a stylus pen, or the like is detected. Alternatively, a display and a keyboard may be used instead of the touch panel.

The image reading unit 16 is an example of an image processing unit and reads an image recorded on a recording medium. The image reading unit 16 is, for example, a scanner. A charge coupled device (CCD) scanner and a contact image sensor (CIS) sensor may be used. In the CCD scanner, a CCD receives light in such a manner that the light is radiated from a light source, reflected on a document, and reduced by a lens. In the CIS scanner, a CIS receives light in such a manner that light beams are serially radiated from a light emitting diode (LED) light source and reflected on a document.

The image forming unit 17 forms an image on a recording medium. The image forming unit 17 is, for example, a printer. An electrophotographic printer and an inkjet printer may be used. The electrophotographic printer forms an image in such a manner that toner caused to attach to a photoconductor is transferred onto a recording medium. The inkjet printer forms an image in such a manner that ink is discharged onto a recording medium.

The network communication I/F 18 transmits and receives various pieces of information to and from another apparatus, for example, the authentication server 50 through the communication network 80.

The short-range communication I/F 19 transmits and receives various pieces of information to and from each mobile terminal 30 through short-range communication (for example, BLE).

### Hardware Configuration of Mobile Terminal

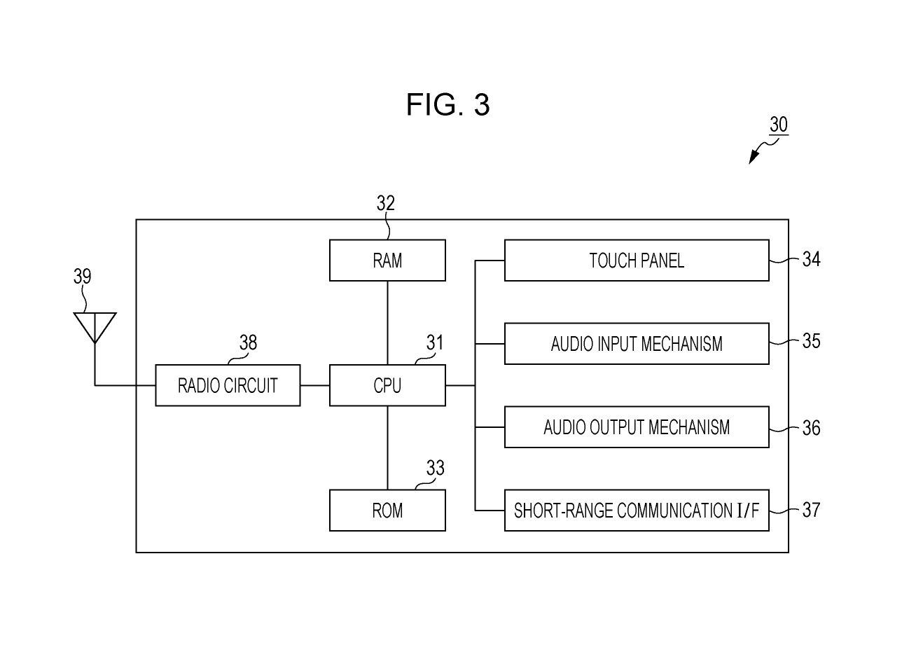

FIG. 3 is a diagram illustrating an example hardware configuration of each mobile terminal 30 in the exemplary embodiment. As illustrated in FIG. 3, the mobile terminal 30 includes a CPU 31 that is a computing unit, a RAM 32 and a ROM 33 that are memories, a touch panel 34 that displays various pieces of information and receives an input operation performed by the user, an audio input mechanism 35 such as a microphone, an audio output mechanism 36 such as a speaker, and a short-range communication I/F 37 that transmits and receives various pieces of information to and from the image reading apparatus 10 through short-range communication (for example, BLE). The mobile terminal 30 also includes a radio circuit 38 and an antenna 39 that are used for performing wireless communication via a base station. The radio circuit 38 includes a baseband large scale integrated circuit (LSI) (not illustrated) that processes digital data signals transmitted and received wirelessly.

### Hardware Configuration of Authentication Server

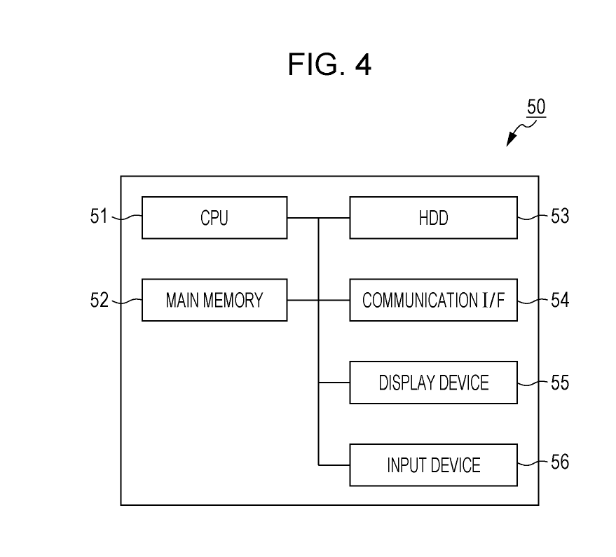

FIG. 4 is a diagram illustrating an example hardware configuration of the authentication server 50 in the exemplary embodiment. As illustrated in FIG. 4, the authentication server 50 includes a CPU 51 that is a computing unit, a main memory 52, and a HDD 53. The main memory 52 and the HDD 53 are memories. The CPU 51 runs an operating system (OS) and software such as applications and thereby implements functions (described later). The main memory 52 is a memory area where the software and data used for running the software are stored. The HDD 53 is a memory area where input data for the software, output data from the software, and other data are stored. The authentication server 50 further includes a communication I/F 54 for performing communication with an external apparatus, a display device 55 such as a display, and an input device 56 such as a keyboard and a mouse.

### Functional Configuration of Information Processing Apparatus

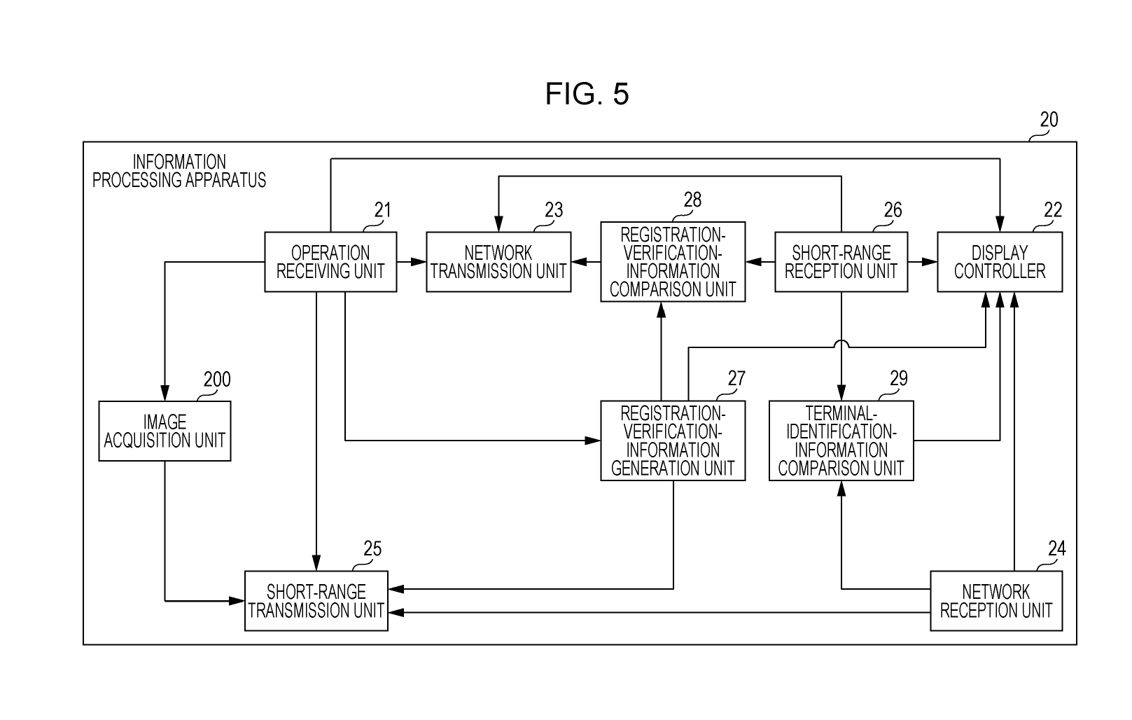

FIG. 5 is a block diagram illustrating an example functional configuration of an information processing apparatus 20 in the exemplary embodiment. The information processing apparatus 20 is regarded as an apparatus implemented in such a manner that the CPU 11 (see FIG. 2) of the image reading apparatus 10 loads the programs for implementing functional units (described later) into the RAM (see FIG. 2) from, for example, the ROM 13 (see FIG. 2) and runs the programs.

As illustrated in FIG. 5, the information processing apparatus 20 includes an operation receiving unit 21, a display controller 22, a network transmission unit 23, a network reception unit 24, a short-range transmission unit 25, and a short-range reception unit 26. The information processing apparatus 20 also includes a registration-verification-information generation unit 27, a registration-verification-information comparison unit 28, a terminal-identification-information comparison unit 29, and an image acquisition unit 200.

When the user performs an operation on the image reading apparatus 10, the operation receiving unit 21 receives the operation and instructs the corresponding functional unit to execute a process for the operation. For example, when the user inputs authentication information, the operation receiving unit 21 instructs the network transmission unit 23 to execute a process of transmitting, to the authentication server 50, the authentication information for requesting authentication of the user or for requesting acquisition of the terminal identification information regarding the corresponding mobile terminal 30. Hereinafter, when being referred to, the authentication information corresponds to a user ID or a password. When the user opens a terminal registration screen or a scanning screen, the operation receiving unit 21 instructs the display controller 22 to execute a process of displaying the designated screen and instructs the short-range transmission unit 25 to execute a process of performing a short-range communication broadcast. When the user selects a terminal name of one of the mobile terminals 30 that is to be registered from a terminal name list, the operation receiving unit 21 instructs the registration-verification-information generation unit 27 to execute a process of generating the registration verification information (described later) and instructs the short-range transmission unit 25 to execute a process of transmitting a registration request notification to the mobile terminal 30 having the selected terminal name. When the user presses the start button after setting a document to be scanned, the operation receiving unit 21 instructs the image acquisition unit 200 to execute a process of acquiring scan data regarding an image read by the image reading unit 16.

The display controller 22 controls displaying of various pieces of information on the operation panel 15 (see FIG. 2). The various pieces of information include information regarding the terminal registration screen used for registering a mobile terminal 30 with the authentication server 50, the terminal name list that lists the mobile terminals 30 that have replied to the short-range communication broadcast, registration verification information (described later) generated by the registration-verification-information generation unit 27, information indicating completion of registration of a mobile terminal 30 with the authentication server 50, information regarding the scanning screen used for scanning, a destination terminal name that is the name of a mobile terminal 30 to which scan data is to be transmitted, and other pieces of information.

The network transmission unit 23 transmits various pieces of information to the authentication server 50. The various pieces of information include user authentication information for requesting authentication of the user or for requesting acquisition of the terminal identification information regarding the corresponding mobile terminal 30, a terminal registration request for requesting registration of the mobile terminal 30 with the authentication server 50, and other pieces of information. In the exemplary embodiment, the network transmission unit 23 is provided as an example of a registration unit that registers a terminal device.

The network reception unit 24 receives various pieces of information from the authentication server 50. The various pieces of information include information indicating an authentication success transmitted after user authentication is requested, information indicating registration completion after a terminal registration request is transmitted, information indicating an authentication success and the terminal identification information that are transmitted after acquisition of the terminal identification information regarding the mobile terminal 30 is requested, and other pieces of information.

The short-range transmission unit 25 transmits various pieces of information to the mobile terminal 30. The various pieces of information include a broadcast signal in the short-range communication, a registration request notification notifying that registration of a mobile terminal 30 is requested, scan data acquired by the image acquisition unit 200, and other pieces of information. In the exemplary embodiment, scan data is used as an example of image data acquired in image processing. Transmission of the scan data to the mobile terminal 30 is an example of a process executed by performing short-range communication with a terminal device or a transmission process executed to transmit image data to the terminal device in the short-range communication. The short-range transmission unit 25 is provided as an example of a processing unit that executes a process. The short-range communication broadcast is used as an example of a request transmitted in the short-range communication.

The short-range reception unit 26 receives various pieces of information from each mobile terminal 30. The various pieces of information include the terminal name of and terminal identification information regarding the mobile terminal 30, the registration verification information (described later) input from the mobile terminal 30, and other pieces of information.

The registration-verification-information generation unit 27 generates registration verification information used for prompting the user to verify whether a mobile terminal 30 regarded as a registration target by the image reading apparatus 10 is a mobile terminal 30 intended by the user to be registered. Conceivable examples of the registration verification information include a personal identification number (PIN) code that is a character string to be input using a software keyboard displayed on the touch panel 34 (see FIG. 3) of the mobile terminal 30 and a gesture pattern defining the order of sliding a finger on sections on the touch panel 34 (see FIG. 3) of the mobile terminal 30. In the exemplary embodiment, the registration verification information is used as an example of designated information.

The registration-verification-information comparison unit 28 compares the registration verification information generated by the registration-verification-information generation unit 27 with the registration verification information received by the short-range reception unit 26. If these pieces of registration verification information match, the registration-verification-information comparison unit 28 instructs the network transmission unit 23 to transmit a terminal registration request to the authentication server 50. The terminal registration request is transmitted to request registration of the mobile terminal 30. The registration is performed in such a manner that the authentication information received by the operation receiving unit 21 is associated with the terminal identification information received by the short-range reception unit 26.

The terminal-identification-information comparison unit 29 compares the terminal identification information received by the network reception unit 24 with the terminal identification information received by the short-range reception unit 26. If these pieces of terminal identification information match, the terminal-identification-information comparison unit 29 instructs the display controller 22 to display the terminal name received by the short-range reception unit 26 on the operation panel 15 (see FIG. 2).

The image acquisition unit 200 acquires scan data of the image read by the image reading unit 16 (see FIG. 2) and instructs the short-range transmission unit 25 to transmit the scan data to the corresponding mobile terminal 30.

### Functional Configuration of Image Memory Device

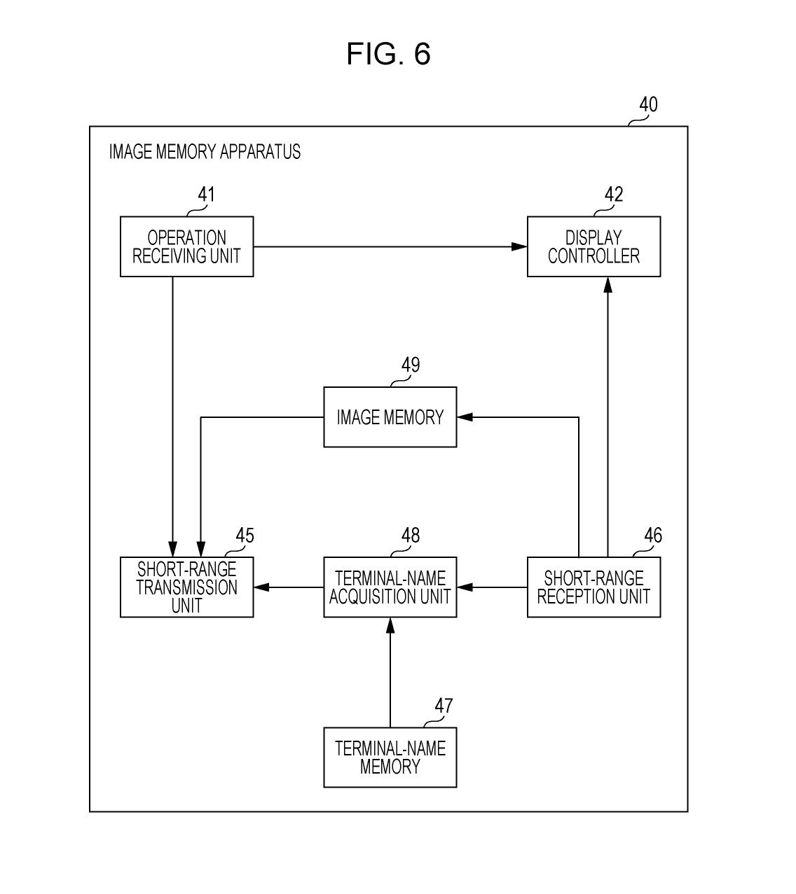

FIG. 6 is a block diagram illustrating an example functional configuration of an image memory apparatus 40 in the exemplary embodiment. The image memory apparatus 40 is regarded as an apparatus implemented in such a manner that the CPU 31 (see FIG. 3) of the mobile terminal 30 loads programs for implementing functional units (described later) into the RAM 32 (see FIG. 3) from, for example, the ROM 33 (see FIG. 3) and runs the programs.

As illustrated in FIG. 6, the image memory apparatus 40 includes an operation receiving unit 41, a display controller 42, a short-range transmission unit 45, and a short-range reception unit 46. The image memory apparatus 40 also includes a terminal-name memory 47, a terminal-name acquisition unit 48, and an image memory 49.

When the user performs an operation on his/her mobile terminal 30, the operation receiving unit 41 receives the operation and instructs the corresponding functional unit to execute a process for the operation. For example, when the user taps a registration request notification displayed on the touch panel 34 (see FIG. 3), the operation receiving unit 41 instructs the display controller 42 to execute a process of displaying a registration-verification-information input screen for inputting registration verification information (screen for inputting, for example, a PIN code or sliding a finger in accordance with a gesture pattern). When the user inputs registration verification information from the registration-verification-information input screen, the operation receiving unit 41 instructs the short-range transmission unit 45 to execute a process of transmitting the registration verification information to the image reading apparatus 10.

The display controller 42 controls displaying of various pieces of information on the touch panel 34 (see FIG. 3). The various pieces of information include the registration request notification indicating that registration of a mobile terminal 30 is requested, the registration-verification-information input screen for inputting the registration verification information, and other pieces of information.

The short-range transmission unit 45 transmits various pieces of information to the image reading apparatus 10. The various pieces of information include the terminal name of and terminal identification information regarding a mobile terminal 30, registration verification information input from the registration-verification-information input screen, and other pieces of information.

The short-range reception unit 46 receives various pieces of information from the image reading apparatus 10. The various pieces of information include a broadcast signal in the short-range communication, the registration request notification indicating that registration of a mobile terminal 30 is requested, scan data acquired in such a manner that the image reading apparatus 10 scans a document, and other pieces of information.

The terminal-name memory 47 stores the terminal name of each mobile terminal 30.

When the short-range reception unit 46 receives a broadcast signal in the short-range communication from the image reading apparatus 10, the terminal-name acquisition unit 48 acquires the terminal name of the mobile terminal 30 from the terminal-name memory 47 and delivers the terminal name to the short-range transmission unit 45.

### Functional Configuration of Information Memory Device

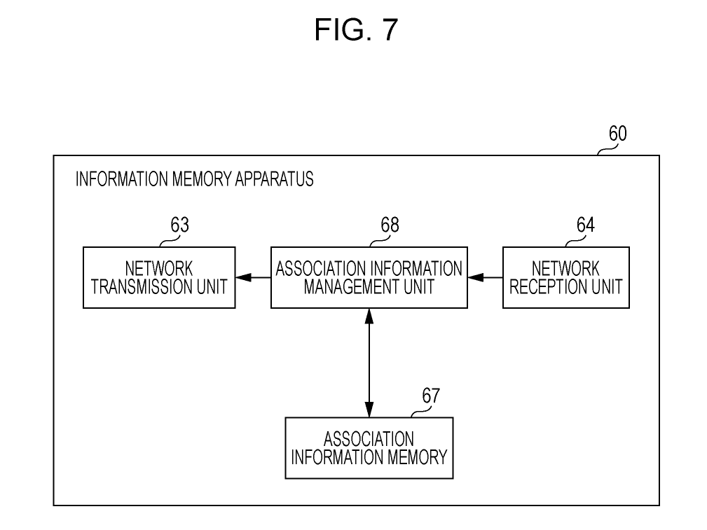

FIG. 7 is a block diagram illustrating an example functional configuration of an information memory apparatus 60 in the exemplary embodiment. The information memory apparatus 60 is regarded as an apparatus implemented in such a manner that the CPU 51 (see FIG. 4) of the authentication server 50 loads programs for implementing functional units (described later) into the main memory 52 (see FIG. 4) from, for example, the HDD 53 (see FIG. 4).

As illustrated in FIG. 7, the information memory apparatus 60 includes a network transmission unit 63, a network reception unit 64, an association information memory 67, and an association information management unit 68.

The network transmission unit 63 transmits various pieces of information to the image reading apparatus 10. The various pieces of information include the information indicating an authentication success transmitted after user authentication is requested, the information indicating registration completion after a terminal registration request is received, the information indicating an authentication success and the terminal identification information that are transmitted after transmission of the terminal identification information regarding the corresponding mobile terminal 30 is requested, and other pieces of information.

The network reception unit 64 receives various pieces of information from the image reading apparatus 10. The various pieces of information include the user authentication information for requesting authentication of the user or for requesting acquisition of the terminal identification information regarding the corresponding mobile terminal 30, the terminal registration request for requesting registration of the mobile terminal 30 with the authentication server 50, and other pieces of information.

The association information memory 67 stores therein information (hereinafter, referred to as association information) in which authentication information regarding the user is associated with the terminal identification information regarding the mobile terminal 30 that is used by the user to store scan data. Even if the association between the terminal identification information regarding the mobile terminal 30 and the authentication information regarding the user is not performed in the association information, the association information is used to authenticate the user because the association information includes the authentication information regarding the user.

When the network reception unit 64 receives the authentication information regarding the user after the authentication information is transmitted to request authentication of the user, the association information management unit 68 judges whether the authentication information has been stored in the association information memory 67. If the authentication information has been stored, the association information management unit 68 notifies the network transmission unit 63 of an authentication success. When the network reception unit 64 receives the authentication information regarding the user and the terminal identification information regarding the mobile terminal 30 that are transmitted in the terminal registration request by which registration of the mobile terminal 30 is requested, the association information management unit 68 stores, in the association information memory 67, the association information in which the authentication information is associated with the terminal identification information. Further, when the network reception unit 64 receives the authentication information regarding the user after the authentication information is transmitted to request acquisition of the terminal identification information regarding the mobile terminal 30, the association information management unit 68 acquires the terminal identification information associated with the authentication information in the association information stored in the association information memory 67 and notifies the network transmission unit 63 of the terminal identification information. In the exemplary embodiment, the authentication information regarding the user is used as an example of operator identification information that identifies an operator, and the terminal identification information regarding the mobile terminal 30 is used as an example of device identification information that identifies a terminal device.

### Operation of Image Reading System

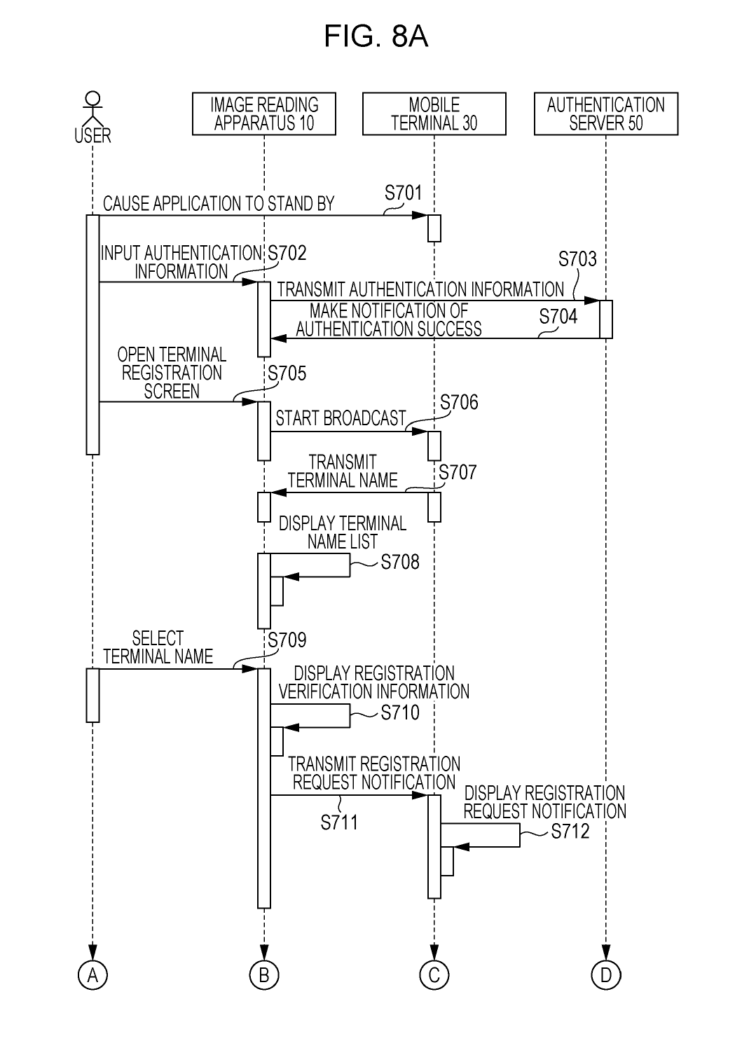

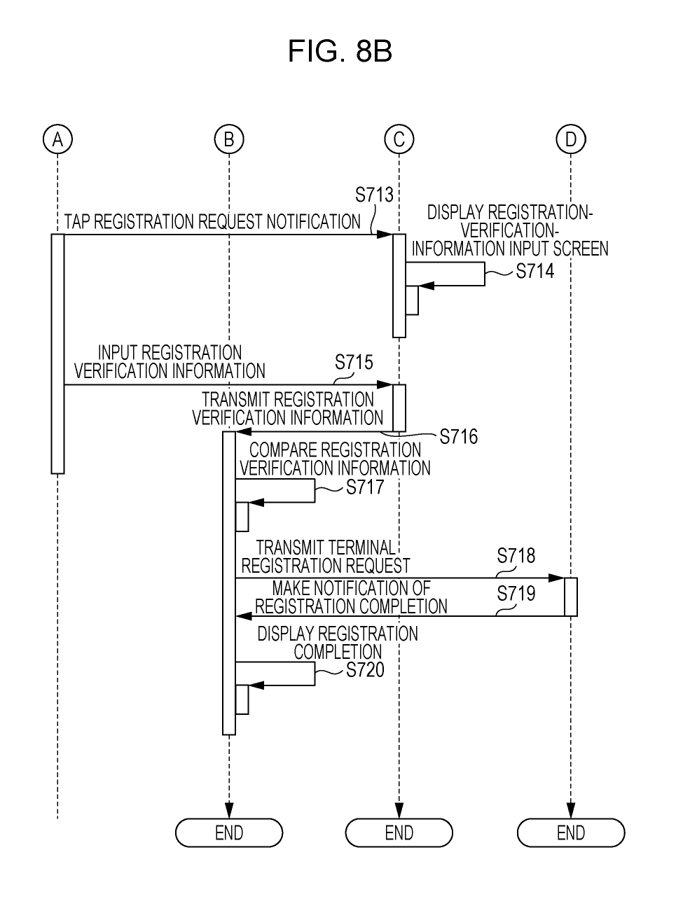

FIGS. 8A and 8B are sequence diagrams illustrating example operations performed when the image reading apparatus 10 registers one of the mobile terminals 30 with the authentication server 50.

As illustrated in FIG. 8A, the user first switches on his/her mobile terminal 30, and an application for the image memory apparatus 40 stands by (S701). Specifically, when the user starts the application, the mobile terminal 30 causes the terminal-name acquisition unit 48, the image memory 49, and other units to enter a ready mode.

The user inputs authentication information in the image reading apparatus 10 (S702). Specifically, when the user inputs the authentication information by performing a manual operation on the operation panel 15 of the image reading apparatus 10 or by bringing an authentication integrated circuit (IC) card close to a card reader of the image reading apparatus 10, the operation receiving unit 21 of the image reading apparatus 10 receives the input of the authentication information.

The image reading apparatus 10 thus transmits the authentication information to the authentication server 50 to request user authentication (S703). Specifically, when the network transmission unit 23 of the image reading apparatus 10 transmits the authentication information to the authentication server 50, the network reception unit 64 performs the user authentication in such a manner that the authentication server 50 receives the authentication information from the image reading apparatus 10 and that the association information management unit 68 refers to association information stored in the association information memory 67. If the user authentication fails, the process returns to step S702. If the user authentication succeeds, the authentication server 50 notifies the image reading apparatus 10 of the authentication success (S704). Specifically, the association information management unit 68 notifies the network transmission unit 63 of the authentication success, and the network transmission unit 63 notifies the image reading apparatus 10 of the authentication success.

The user selects the “mobile terminal registration” icon from the menu displayed on the operation panel 15 of the image reading apparatus 10 to open the terminal registration screen (S705). Specifically, when the user presses the “mobile terminal registration” icon, the operation receiving unit 21 of the image reading apparatus 10 receives the pressing of the “mobile terminal registration” icon, and the display controller 22 performs control to display the terminal registration screen on the operation panel 15.

The image reading apparatus 10 thus starts a short-range communication broadcast (for example, a BLE broadcast) (S706). Specifically, the short-range transmission unit 25 transmits a broadcast signal in the short-range communication.

Thereafter, each of the mobile terminals 30 having received the broadcast from the image reading apparatus 10 establishes one-to-one communication with the image reading apparatus 10 (for example, BLE connection communication) and transmits its own terminal name (S707). Specifically, the terminal-name acquisition unit 48 of the mobile terminal 30 acquires the terminal name stored in the terminal-name memory 47, and the short-range transmission unit 45 transmits the terminal name to the image reading apparatus 10. The image reading apparatus 10 acquires the terminal identification information regarding the mobile terminal 30 (for example, a BD address) by establishing the one-to-one communication.

The image reading apparatus 10 thus displays a terminal name list on the operation panel 15 after an elapse of a predetermined period of time (S708). Specifically, the short-range reception unit 26 receives terminal names from the mobile terminals 30, and the display controller 22 performs control to display the terminal name list including the received terminal names on the operation panel 15.

Each mobile terminal 30 may transmit only a reply signal in step S707 without transmitting the terminal name. In this case, in step S708, the image reading apparatus 10 may display a list of pieces of terminal identification information regarding the mobile terminals 30 (for example, the BD addresses) acquired in step S707 on the operation panel 15. However, in the following description, the mobile terminals 30 transmit the terminal names in step S707, and the image reading apparatus 10 displays the terminal name list in step S708.

The user then selects the terminal name of the mobile terminal 30 to be registered from the terminal name list (S709). Specifically, when the user selects the terminal name, the operation receiving unit 21 of the image reading apparatus 10 receives the selection of the terminal name.

If only one mobile terminal 30 has replied in step S707, the image reading apparatus 10 does not have to perform steps S708 and S709.

The image reading apparatus 10 thus generates registration verification information and displays the registration verification information on the operation panel 15 (S710). Specifically, the registration-verification-information generation unit 27 generates the registration verification information, and the display controller 22 performs control to display the registration verification information on the operation panel 15.

The image reading apparatus 10 also transmits, in the short-range connection communication (for example, BLE connection communication), a registration request notification to the mobile terminal 30 selected in step S709 (S711). Specifically, the short-range transmission unit 25 transmits the registration request notification to the mobile terminal 30 having the terminal name received by the operation receiving unit 21.

Upon receiving the registration request notification, the mobile terminal 30 selected in step S709 displays the registration request notification on the screen of the mobile terminal 30 (S712). Specifically, the short-range reception unit 46 receives the registration request notification, and the display controller 42 performs control to display the registration request notification on the touch panel 34.

As illustrated in FIG. 8B, the user taps the registration request notification displayed on the mobile terminal 30 (S713). The mobile terminal 30 thus displays the registration-verification-information input screen on the touch panel 34 (S714). Specifically, if the user taps the registration request notification, the operation receiving unit 41 of the mobile terminal 30 receives the tapping, and the display controller 42 performs control to display the registration-verification-information input screen on the touch panel 34.

The user inputs the registration verification information into the mobile terminal 30 (S715). Specifically, when the user inputs the registration verification information by pressing the keys corresponding to the PIN code on the registration-verification-information input screen displayed on the touch panel 34 of the mobile terminal 30 or by sliding a finger in accordance with the gesture pattern on the registration-verification-information input screen, the operation receiving unit 41 of the mobile terminal 30 receives the input of the registration verification information. The mobile terminal 30 thus transmits the registration verification information to the image reading apparatus 10 in the short-range connection communication (for example, the BLE connection communication) (S716). Specifically, the short-range transmission unit 45 transmits the registration verification information received by the operation receiving unit 41 to the image reading apparatus 10.

Upon receiving the registration verification information, the image reading apparatus 10 compares the received registration verification information with the registration verification information generated in step S710 (S717). Specifically, the short-range reception unit 26 receives the registration verification information, and the registration-verification-information comparison unit 28 compares the registration verification information received by the short-range reception unit 26 with the registration verification information generated by the registration-verification-information generation unit 27.

If these pieces of registration verification information match, the image reading apparatus 10 identifies the mobile terminal 30 as a mobile terminal 30 to be registered. The image reading apparatus 10 transmits, to the authentication server 50, a terminal registration request for requesting the registration of the mobile terminal 30 (S718). The terminal registration request includes the authentication information received in step S702 and the terminal identification information regarding the mobile terminal 30 acquired when the short-range connection communication is established in step S707. Specifically, if the registration-verification-information comparison unit 28 judges that the registration verification information received by the short-range reception unit 26 and the registration verification information generated by the registration-verification-information generation unit 27 match, the network transmission unit 23 transmits, to the authentication server 50, the authentication information input of which is received by the operation receiving unit 21 and the terminal identification information regarding the mobile terminal 30 received by the short-range reception unit 26. If the registration-verification-information comparison unit 28 judges that the registration verification information received by the short-range reception unit 26 and the registration verification information generated by the registration-verification-information generation unit 27 do not match, the display controller 22 performs control to display an error message on the operation panel 15.

Thereafter, the authentication server 50 receives the authentication information and the terminal identification information, registers these pieces of information in association with each other, and notifies the image reading apparatus 10 of the completion of the registration (S719). Specifically, the network reception unit 64 receives the authentication information and the terminal identification information, the association information management unit 68 stores, in the association information memory 67, the association information in which the authentication information is associated with the terminal identification information, and the network transmission unit 63 notifies the image reading apparatus 10 of the completion of the registration of the mobile terminal 30.

The image reading apparatus 10 thus displays the completion of the registration on the operation panel 15 (S720). Specifically, the network reception unit 24 receives the completion of the registration of the mobile terminal 30 from the authentication server 50, and the display controller 22 performs control to display the completion of the registration of the mobile terminal 30 on the operation panel 15.

Note that in the example operations, the image reading apparatus 10 transmits only the registration request notification to the mobile terminal 30 in step S711, but transmitted information is not limited thereto. The image reading apparatus 10 may transmit, to the mobile terminal 30, the registration verification information generated in step S710 together with the registration request notification. In this case, the image reading apparatus 10 does not compare the pieces of registration verification information. Instead, the mobile terminal 30 compares the registration verification information transmitted from the image reading apparatus 10 with the registration verification information input by the user in step S715. If these pieces of information match, the mobile terminal 30 may transmit, to the image reading apparatus 10, a notification indicating registration permission.

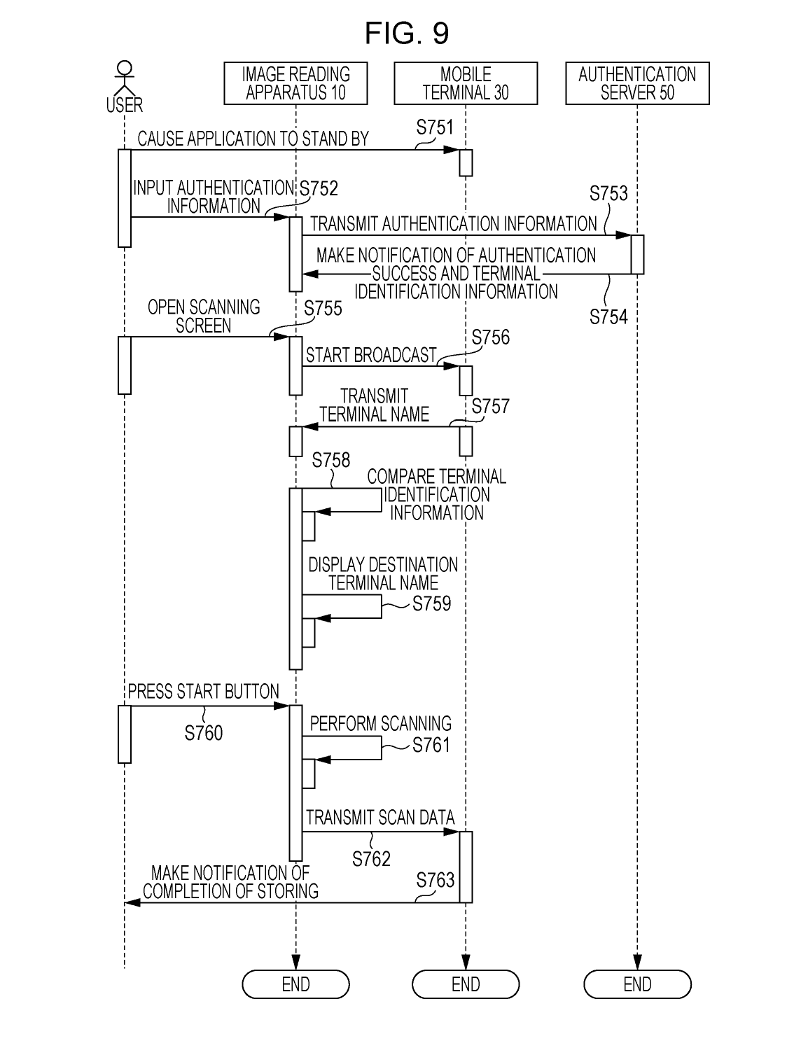

FIG. 9 is a sequence diagram illustrating example operations performed when an image scanned by the image reading apparatus 10 is stored in the mobile terminal 30.

As illustrated in FIG. 9, the user first switches on his/her mobile terminal 30, and the application for the image memory apparatus 40 stands by (S751). Specifically, when the user starts the application, the mobile terminal 30 causes the terminal-name acquisition unit 48, the image memory 49, and other units to enter the ready mode.

The user inputs the authentication information in the image reading apparatus 10 (S752). Specifically, when the user inputs the authentication information by performing a manual operation on the operation panel 15 of the image reading apparatus 10 or by bringing the authentication IC card close to the card reader of the image reading apparatus 10, the operation receiving unit 21 of the image reading apparatus 10 receives the input of the authentication information.

The image reading apparatus 10 thus transmits the authentication information to the authentication server 50 to request acquisition of the terminal identification information regarding the mobile terminal 30 (for example, a BD address) (S753). Specifically, when the network transmission unit 23 of the image reading apparatus 10 transmits the authentication information to the authentication server 50, the network reception unit 64 of the authentication server 50 receives the authentication information from the image reading apparatus 10, and the association information management unit 68 performs the user authentication by referring to association information stored in the association information memory 67. If the user authentication fails, the process returns to step S752.

In contrast, if the user authentication succeeds, the authentication server 50 notifies the image reading apparatus 10 of the authentication success and the terminal identification information regarding the mobile terminal 30 (for example, the BD address) registered in association with the authentication information (S754). Specifically, the association information management unit 68 acquires the terminal identification information regarding the mobile terminal 30 associated with the authentication information in the association information stored in the association information memory 67. The association information management unit 68 notifies the network transmission unit 63 of the authentication success and the terminal identification information. The network transmission unit 63 notifies the image reading apparatus 10 of the authentication success and the terminal identification information.

The user selects the “scan” icon on the operation panel 15 of the image reading apparatus 10 to open the scanning screen (S755). Specifically, when the user presses the “scan” icon, the operation receiving unit 21 of the image reading apparatus 10 receives the pressing of the “scan” icon, and the display controller 22 performs control to display the scanning screen on the operation panel 15.

The image reading apparatus 10 thus starts a short-range communication broadcast (for example, a BLE broadcast) (S756). Specifically, the short-range transmission unit 25 transmits a broadcast signal in the short-range communication.

Thereafter, each of the mobile terminals 30 having received the broadcast from the image reading apparatus 10 establishes one-to-one communication with the image reading apparatus 10 (for example, BLE connection communication) and transmits its own terminal name (S757). Specifically, the terminal-name acquisition unit 48 acquires the terminal name stored in the terminal-name memory 47, and the short-range transmission unit 45 transmits the terminal name to the image reading apparatus 10. The image reading apparatus 10 acquires the terminal identification information regarding the mobile terminal 30 (for example, a BD address) by establishing the one-to-one communication.

After an elapse of a predetermined period of time, the image reading apparatus 10 thus compares the terminal identification information regarding the mobile terminal 30 (for example, the BD address) notified in step S754 with the terminal identification information regarding each of the mobile terminals 30 (for example, the BD address) that has replied in step S757 (S758). Specifically, the terminal-identification-information comparison unit 29 compares the terminal identification information received by the network reception unit 24 with the terminal identification information received by the short-range reception unit 26.

If the terminal identification information received by the network reception unit 24 and one of the pieces of terminal identification information received by the short-range reception unit 26 (for example, the BD address) match, the image reading apparatus 10 identifies the mobile terminal 30 indicated by the terminal identification information as a transmission destination mobile terminal 30 and displays, on the operation panel 15, a destination terminal name that is the name of the mobile terminal 30 (S759). Specifically, if the terminal-identification-information comparison unit 29 judges that the terminal identification information received by the network reception unit 24 and one of the pieces of terminal identification information received by the short-range reception unit 26 match, the display controller 22 performs control to display the terminal name received by the short-range reception unit 26 on the operation panel 15. If the terminal-identification-information comparison unit 29 judges that the terminal identification information received by the network reception unit 24 and any one of the pieces of terminal identification information received by the short-range reception unit 26 do not match, the display controller 22 performs control to display an error message on the operation panel 15.

Each mobile terminal 30 may transmit only a reply signal in step S757 without transmitting the terminal name. In this case, if the terminal identification information regarding the mobile terminal 30 (for example, the BD address) notified in step S754 and one of the pieces of terminal identification information regarding the respective mobile terminals 30 (for example, the BD addresses) acquired in step S757 match, the image reading apparatus 10 may display the terminal identification information (for example, the BD address) on the operation panel 15 in step S759.

The user checks the displayed terminal name, sets a document on the image reading apparatus 10, sets parameters, and presses the start button (S760). Specifically, when the user presses the start button, the operation receiving unit 21 of the image reading apparatus 10 receives the pressing of the start button.

The image reading apparatus 10 thus scans the document (S761). Specifically, the image reading unit 16 reads an image from the document. The image reading apparatus 10 transmits scan data to the destination mobile terminal 30 (S762). Specifically, the image acquisition unit 200 acquires the image read by the image reading unit 16 as the scan data, and the short-range transmission unit 25 transmits the scan data to the destination mobile terminal 30 by using the terminal identification information regarding the mobile terminal 30 having the terminal name displayed on the operation panel 15.

The mobile terminal 30 receives the scan data from the image reading apparatus 10 and stores the scan data. After storing the scan data, the mobile terminal 30 notifies the user of the completion of storing the scan data (S763). Specifically, the short-range reception unit 46 receives the scan data from the image reading apparatus 10, and the image memory 49 stores the scan data. The mobile terminal 30 notifies the user of the completion of storing of the scan data, for example, in such a manner the audio output mechanism 36 outputs sound from the speaker or that a vibration function (not illustrated) vibrates the mobile terminal 30. Alternatively, the completion may be notified by using a screen of a wearable terminal operating in conjunction with the mobile terminal 30.

Note that in the example operations, the mobile terminal 30 transmits only the terminal name to the image reading apparatus 10 in step S757, but transmitted information is not limited thereto. In a system where multiple pieces of terminal identification information regarding the respective mobile terminals 30 are registered in association with a piece of authentication information regarding a user, each mobile terminal 30 may transmit, to the image reading apparatus 10, a received signal strength indicator (RSSI) of the BLE broadcast received in step S756 together with the terminal name. In this case, if the image reading apparatus 10 fails to identify the mobile terminal 30 in step S758, the image reading apparatus 10 may identify one of the mobile terminals 30 that has the highest RSSI as the destination mobile terminal 30.

In addition, in the example operations, the mobile terminal 30 displays only one destination terminal name on the operation panel 15 in step S759, but displayed information is not limited thereto. In the system where multiple pieces of terminal identification information regarding the respective mobile terminals 30 are registered in association with a piece of authentication information regarding a user, the mobile terminal 30 may display, on the operation panel 15, a list of terminal names of the mobile terminals 30 that have replied within a predetermined period of time and may thus prompt the user to select a destination terminal name.

The highest RSSI or the user's selection is herein the condition for identifying a mobile terminal 30 in the case where the multiple pieces of terminal identification information regarding the mobile terminals 30 are registered in association with one piece of authentication information regarding a user, but another condition may be used. That is, the highest SSI and the user's selection are examples of a condition for identifying a terminal device as being closest to the information processing apparatus.

Note that although the exemplary embodiment applied to the example where the image reading apparatus 10 transmits the scan data regarding the image read by the image reading unit 16 to the mobile terminal 30 in the short-range communication has been described, an applied case is not limited thereto. For example, the exemplary embodiment may be applied to a case where the image reading apparatus 10 transmits image data stored in advance in the HDD 14 to the mobile terminal 30 in the short-range communication. Alternatively, the exemplary embodiment may be applied to a case where the image reading apparatus 10 receives print data stored in advance by the mobile terminal 30. In this case, the print data is an example of image data used in image processing, and the image forming unit 17 (see FIG. 2) is an example of the image processing unit.

To transmit such image data, Classic Bluetooth (registered trademark) and Wi-Fi Direct (registered trademark) that exhibit a higher speed than BLE may be used instead of BLE. However, an address for establishing the connection may be transmitted in BLE connection communication.

Further, in the exemplary embodiment, the user authentication is performed using the authentication server 50, and the terminal identification information regarding the mobile terminal 30 is registered with the authentication server 50 in association with the authentication information regarding the user. However, a configuration without using the authentication server 50 is also conceivable. That is, the image reading apparatus 10 may hold a user ID and a password, perform the user authentication by itself, and register the terminal identification information regarding the mobile terminal 30 with the image reading apparatus 10 in association with the authentication information regarding the user.

Still further, in the exemplary embodiment, one authentication server 50 is provided for one image reading apparatus 10, but one authentication server 50 may be shared by multiple image reading apparatuses 10. The image reading apparatus 10 in the exemplary embodiment may also be an information processing apparatus such as a PC.

### Program

The process executed by the information processing apparatus 20 in the exemplary embodiment is provided as a program such as application software.

In other words, the program implementing the exemplary embodiment is regarded as a program for causing a computer to implement a function of registering terminal devices with the computer or a different device in association with operators who operate the terminal devices and to implement a function of executing a process by performing, in response to an instruction for the process given by one of the operators, short-range communication with one of the terminal devices that is registered in association with the operator.

The program implementing the exemplary embodiment may be provided using not only a communication unit but also in such a manner as to be stored in a recording medium such as a compact disc read-only memory (CD-ROM).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a processor configured to act as:
a registration unit that registers a plurality of terminal devices with the information processing apparatus or a different apparatus in association with a plurality of operators who operate the plurality of terminal devices;
a processing unit that executes a process by performing, in response to an instruction for the process given by a specific one of the operators, short-range communication with a specific one of the terminal devices that is registered in association with the specific one operator;
a short-range reception unit that receives a first registration verification information from at least one of the plurality of terminal devices;
a registration-verification-information generation unit that generates second registration verification information; and
a registration verification comparison unit,
wherein the first registration verification information received by the short-range reception unit is a PIN code entered by a user, and the first registration verification information is compared to the second registration verification information which is a PIN code generated by the registration-verification-information generation unit, and
wherein when it is judged by the registration verification comparison unit that the first registration verification information received by the short range reception unit is different from the second registration verification information generated by the registration-verification-information generation unit, an error message is displayed on a display.

2. The information processing apparatus according to claim 1,
wherein each of the plurality of terminal devices having replied to a request transmitted in the short-range communication is selected by a corresponding one of the plurality of operators, and the registration unit registers the selected terminal devices in association with the corresponding one operator.

3. The information processing apparatus according to claim 2,
wherein if designated information is input in the terminal device selected from the plurality of terminal devices by the corresponding one operator, the registration unit registers the selected terminal device in association with the corresponding one operator.

4. The information processing apparatus according to claim 1,
wherein if the plurality of terminal devices having replied to a request transmitted in the short-range communication include the specific one terminal device, the processing unit executes the process by performing the short-range communication with the specific one terminal device in response to the instruction for the process given by the specific one operator.

5. The information processing apparatus according to claim 1,
wherein the plurality of operators each operate two or more of the terminal devices, and the registration unit registers the two or more terminal devices in association with a corresponding one of the plurality of operators, and
wherein if the plurality of terminal devices having replied to a request transmitted in the short-range communication include the two or more terminal devices, the processing unit executes the process by performing, in response to the instruction for the process given by the specific one operator, the short-range communication with one of the two or more terminal devices that satisfies a condition for identifying a terminal device as being closest to the information processing apparatus.

6. The information processing apparatus according to claim 1,
wherein the registration unit registers, with the information processing apparatus or the different apparatus, a plurality of pieces of association information in which a plurality of pieces of device identification information are associated with a plurality of pieces of operator identification information, the plurality of pieces of device identification information respectively identifying the plurality of terminal devices operated by the plurality of operators, the plurality of pieces of operator identification information respectively identifying the plurality of operators, and
wherein the processing unit executes the process by performing, in response to the instruction for the process given by the specific one operator, the short-range communication with the specific one terminal device that is identified by a specific one of the pieces of device identification information that is associated, in one of the pieces of association information, with a specific one of the pieces of operator identification information that identifies the specific one operator.

7. An image processing apparatus comprising:
a processor configured to act as:
a registration unit that registers a plurality of terminal devices with the image processing apparatus or a different apparatus in association with a plurality of operators who operate the plurality of terminal devices;
an image processing unit that performs image processing in response to an instruction for the image processing given by a specific one of the operators;
a processing unit that executes at least one of a transmission process or a reception process, the transmission process being executed in short-range communication to transmit image data acquired in the image processing to a specific one of the terminal devices that is registered in association with the specific one operator, the reception process being executed in the short-range communication to receive image data to be used in the image processing from the specific one terminal device that is registered in association with the specific one operator;
a short-range reception unit that receives a first registration verification information from at least one of the plurality of terminal devices;
a registration-verification-information generation unit that generates second registration verification information; and
a registration verification comparison unit,
wherein the first registration verification information received by the short-range reception unit is a PIN code entered by a user, and the first registration verification information is compared to the second registration verification information which is a PIN code generated by the registration-verification-information generation unit, and
wherein when it is judged by the registration verification comparison unit that the first registration verification information received by the short range reception unit is different from the second registration verification information generated by the registration-verification-information generation unit, an error message is displayed on a display.

8. A non-transitory computer readable medium storing a program causing a computer to execute a process for processing information, the process comprising:
registering a plurality of terminal devices with the computer or a different apparatus in association with a plurality of operators who operate the plurality of terminal devices;
executing a process by performing, in response to an instruction for the process given by a specific one of the operators, short-range communication with a specific one of the terminal devices that is registered in association with the specific one operator;
comparing first registration verification information received by a short-range reception unit which is a PIN code entered by a user, to second registration verification information which is a PIN code generated by a registration-verification-information generation comparison unit, and
judging whether the first registration verification information is different from the second registration verification information, and if so, displaying an error message on a display.
